(19) United States
(12) Patent Application Publication
(10) Pub. No.: US 2009/0239659 A1
(43) Pub. Date: Sep. 24, 2009

(54) GAMING MACHINE ACCEPTING SIDE BET AND GAMING METHOD

(75) Inventor: Kazumasa Yoshizawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/405,176

(22) Filed: Mar. 16, 2009

Related U.S. Application Data
(60) Provisional application No. 61/038,956, filed on Mar. 24, 2008.

(51) Int. Cl. A63F 9/24; A63F 13/00

(52) U.S. Cl. 463/25; 463/30

(57) ABSTRACT

A gaming machine of the present invention offers a special payout when a specific card is included in the player's cards, in a case where a side BET has been placed in a card game using player's cards and dealer's cards.

### CROSS-REFERENCE TO RELATED APPLICATIONS

This application claims benefit of priority based on U.S. Provisional Patent Application No. 61/038,956 filed on Mar. 24, 2008. The contents of this application are incorporated herein by reference in their entirety.

### BACKGROUND OF THE INVENTION

1. Field of the Invention

The present invention relates to a gaming machine accepting a side BET and a gaming method.

2. Discussion of the Background

Conventionally, there have been gaming machines capable of accepting a side BET different from a normal BET. For example, in Blackjack, when an up card out of dealer's two cards is an “A” card, a player can place a side BET in addition to a normal BET. In the case of placing the side BET, the player adds the bet by half of an initial bet. When the dealer's hand is “Natural 21”, a payout in an amount twice as large as the amount of the side BET is paid buck. Further, for example, in Caribbean Stud Poker, a side BET is cumulatively accumulated as a progressive jackpot. When a player places a side BET in addition to an ante (normal BET), he or she can acquire part or the whole of the progressive jackpot, in accordance with the established hand. A game capable of accepting a side BET of this kind is disclosed in, for example, U.S. Pat. No. 6,789,801, U.S. Pat. No. 5,711,525, and U.S. Pat. No. 6,874,786.

Further, as disclosed in US 2006/0287043-A1 and US 2006/0009283-A1, there exist gaming systems where a plurality of gaming machines (player terminals) are linked so that a plurality of players can play a common game.

However, the conventional gaming machine that accepts a side BET has not been capable of realizing both additions of high gaming properties to a game which becomes executable by placing a side BET (hereinafter also referred to as side game) and an increase of a possibility of conducting a payout in a large amount such as a progressive jackpot in the side game. For example, there has been a problem that it is not possible to have a player place a side BET willingly in the case that, even when a side BET is placed, an amount of payout to be conducted in the side game is small (e.g. a few times as much as an amount of a side BET) or the side game itself lacks interesting factors.

The present invention was made in view of the foregoing problem, and has an object to provide a gaming machine capable of making a player place a side BET willingly, and a gaming method.

The contents of U.S. Pat. No. 6,789,801, U.S. Pat. No. 5,711,525, U.S. Pat. No. 6,874,786, US 2006/0287043-A1, and US 2006/0009283-A1 are incorporated herein by reference in their entirety.

### SUMMARY OF THE INVENTION

A first aspect of the present invention provides a gaming machine having the following configuration.

Namely, the above-mentioned gaming machine comprises a display capable of displaying a plurality of cards; an input device; and a controller. The controller is programmed so as to execute the processing of (a) accepting a normal BET from the input device, (b) accepting a side BET different from the normal BET, from the input device, (c) displaying player's cards and dealer's cards to the display, (d) executing a normal game for determining winning or losing based on the player's cards and the dealer's cards, (e) offering a normal payout based on the normal BET when determining that a player has won in the normal game, (f) determining whether or not a specific card is included in the player's cards when the side BET has been placed, and (g) offering a special payout when determining in the processing (f) that the specific card is included in the player's cards.

According to the above gaming machine, in a case where a side BET has been placed in a card game using player's cards and dealer's cards, when a specific card (e.g. a playing card of “Ace of Spade”) is included in the player's cards, a special payout is offered.

Since a side game (game for determining whether or not the specific card is included) is played using the player's cards dealt in a normal game, a player interested in the normal game tends not to have a sense of resistance toward placing the side BET. Further, since a new gaming property of determining whether or not the specific card is included is added, an interesting aspect of the game itself can be further enhanced.

Moreover, since the special payout is offered when the specific card is included in the side game, it is possible to increase a sense of anticipation of the player for the side game (special payout).

Consequently, it is possible to make the player have a high motivation to place the side BET.

Further, it is desirable that the above-mentioned gaming machine has the following configuration.

Namely, the controller is further programmed so as to execute processing of (h) determining the specific card when the side BET has been placed.

According to the above gaming machine, since the specific card is not a fixed card previously determined, but a card determined in each game, it is possible to enhance the game properties of the side game, and also increase a sense of anticipation of the player for the special payout.

Further, it is desirable that the above-mentioned gaming machine has the following configuration.

Namely, the controller is further programmed so as to execute processing of (i) determining the specific card based on an input from the input device when the side BET has been placed, and is programmed so as to execute the processing (c) after the processing (i).

According to the above gaming machine, since the specific card is not a fixed card previously determined, but a card determined by an input of the player in each game, it is possible to make the player strongly aware of being participating in the side game, in addition to enhancing the game properties of the side game so as to increase a sense of anticipation of the player for the special payout.

A second aspect of the present invention provides a gaming machine having the following configuration.

Namely, the gaming machine comprises a display capable of displaying a plurality of cards; an input device; and a controller. The controller is programmed so as to execute the processing of (a) accepting a normal BET from the input device, (b) accepting a side BET different from the normal BET, from the input device, (c) cumulatively accumulating a predetermined percentage of game media side-bet from the input device, (d) displaying player's cards and dealer's cards to the display, (e) executing a normal game for determining winning or losing based on the player's cards and the dealer's cards, (f) offering a normal payout based on the normal BET when determining that a player has won in the normal game, (g) determining whether or not a specific card is included in the player's cards when the side BET has been placed, and (h) offering a special payout from the game media cumulatively accumulated in the processing (c), when determining in the processing (g) that the specific card is included in the player's cards.

According to the above gaming machine, in a case where a side BET has been placed in a card game using player's cards and dealer's cards, when a specific card (e.g. a playing card of “Ace of Spade”) is included in the player's cards, a special payout is offered.

Further, part of the side-bet game media is cumulatively accumulated, for example as a progressive jackpot, and the special payout in the side game is offered from the accumulated game media.

Since a side game (game for determining whether or not the specific card is included) is played using the player's cards dealt in a normal game, a player interested in the normal game tends not to have a sense of resistance toward placing the side BET. Further, since a new gaming property of determining whether or not the specific card is included is added, an interesting aspect of the game itself can be further enhanced.

Moreover, since the special payout is offered when the specific card is included in the side game, it is possible to increase a sense of anticipation of the player for the side game (special payout).

Further, since the special payout is part of the side-bet game media cumulatively accumulated, it is possible for the player to acquire a payout in a large amount in the side game.

Accordingly, it is possible to make the player have a high motivation to place the side BET.

Further, it is desirable that the above-mentioned gaming machine has the following configuration.

Namely, the controller is further programmed so as to execute processing of (i) determining the specific card when the side BET has been placed.

According to the above gaming machine, since the specific card is not a fixed card previously determined, but a card determined in each game, it is possible to enhance the game properties of the side game, and also increase a sense of anticipation of the player for the special payout.

Further, it is desirable that the above-mentioned gaming machine has the following configuration.

Namely, the controller is further programmed so as to execute processing of (j) determining the specific card based on an input from the input device when the side BET has been placed, and is programmed so as to execute the processing of the processing (d) after the processing (J).

According to the above gaming machine, since the specific card is not a fixed card previously determined, but a card determined by an input of the player in each game, it is possible to make the player strongly aware of being participating in the side game, in addition to enhancing the game properties of the side game so as to increase a sense of anticipation of the player for the special payout.

A third aspect of the present invention provides a playing method of a card game, the playing method having the following configuration.

Namely, the playing method of a card game comprises steps of: (a) placing a normal BET;

(b) placing a side BET different from the normal BET;

(c) dealing cards to a player as player's cards, while dealing cards to a dealer as dealer's cards;

(d) executing a normal game for determining winning or losing based on the player's cards and the dealer's cards;

(e) offering a normal payout based on the normal BET when determining that a player has won in the normal game;

(f) determining whether or not a specific card is included in the player's cards when the side BET has been placed; and

(g) offering a special payout when determining in the step (f) that the specific card is included in the player's cards.

According to the above playing method of a card game, in a case where a side BET has been placed in a card game using player's cards and dealer's cards, when a specific card (e.g. a playing card of “Ace of Spade”) is included in the player's cards, a special payout is offered.

Since a side game (game for determining whether or not the specific card is included) is played using the player's cards dealt in a normal game, a player interested in the normal game tends not to have a sense of resistance toward placing the side BET. Further, since a new gaming property of determining whether or not the specific card is included is added, an interesting aspect of the game itself can be further enhanced.

Moreover, since the special payout is offered when the specific card is included in the side game, it is possible to increase a sense of anticipation of the player for the side game (special payout).

Consequently, it is possible to make the player have a high motivation to place the side BET.

Further, it is desirable that the above-mentioned playing method of a card game has the following configuration.

Namely, the playing method of a card game further comprises steps of: (h) determining the specific card when the side BET has been placed.

According to the above playing method of a card game, since the specific card is not a fixed card previously determined, but a card determined in each game, it is possible to enhance the game properties of the side game, and also increase a sense of anticipation of the player for the special payout.

Further, it is desirable that the above-mentioned playing method of a card game has the following configuration.

Namely, the playing method of a card game further comprises steps of (i) determining the specific card based on a selection by the player when the side BET has been placed, wherein the step (c) is executed after the step (i).

According to the above playing method of a card game, since the specific card is not a fixed card previously determined, but a card determined by an input of the player in each game, it is possible to make the player strongly aware of being participating in the side game, in addition to enhancing the game properties of the side game so as to increase a sense of anticipation of the player for the special payout.

### BRIEF DESCRIPTIONS OF THE DRAWINGS

FIG. 1A is a flowchart showing card game processing executed in a station provided in a gaming machine according to a first embodiment of the present invention.

FIG. 1B is a flowchart showing the card game processing executed in the station provided in the gaming machine according to the first embodiment of the present invention.

FIG. 2 is a perspective view schematically showing an appearance configuration of the gaming machine according to the first embodiment of the present invention.

FIG. 3 is a perspective view schematically showing an appearance configuration of the station in the gaming machine.

FIG. 4 is a view showing an example of images displayed to a front display provided in the gaming machine in the first embodiment.

FIG. 5 is a view showing an example of images displayed to a liquid crystal display provided in the station in the first embodiment.

FIG. 6 is a view showing an example of images displayed to the liquid crystal display provided in the station in the first embodiment.

FIG. 7 is a view showing an example of images displayed to the liquid crystal display provided in the station in the first embodiment.

FIG. 8 is a block diagram showing an internal configuration of the gaming machine.

FIG. 9 is a block diagram showing an internal configuration of the station in the gaming machine.

FIG. 10 is a flowchart showing main processing performed in a main control portion and the station.

FIG. 11 is a flowchart showing a procedure of activation processing.

FIG. 12 is a flowchart showing card game processing executed in the main control portion in the gaming machine according to the first embodiment.

FIG. 13 is a view showing an example of images displayed to the liquid crystal display provided in the station in a second embodiment.

FIG. 14 is a flowchart showing card game processing executed in the main control portion in the gaming machine according to the second embodiment.

FIG. 15A is a flowchart showing card game processing executed in a station provided in a gaming machine according to the second embodiment.

FIG. 15B is a flowchart showing the card game processing executed in the station provided in the gaming machine according to the second embodiment.

### DESCRIPTION OF THE EMBODIMENTS

An embodiment of the present invention is described based on the drawings.

In the following embodiment, the case of playing Pai Gow Poker is described. First, the rule of Pai Gow Poker is described.

In Pai Gow Poker, a deck (53 cards) of playing cards including one Joker is used, and a single or a plurality of players play against a dealer.

First, seven cards each are dealt to the dealer and the player. The dealer and the player divide their seven cards into a set of five cards and a set of two cards. At this time, the five-card hand (high hand) must rank as high as or higher than the two-card hand (low hand). Next, the dealer's five-card hand and the player's five-card hand are compared to determine which ranks higher. In the same manner, the dealer's two-card hand and the player's two-card hand are compared to determine which ranks higher. When both the dealer's five-card hand and two-card hand rank higher, the dealer wins. When both the player's five-card hand and two-card hand rank higher, the player wins. When, out of the five-card hand and the two-card hand, one of the player's hands ranks higher than the dealer's corresponding hand and the other of the dealer's hands ranks higher than the player's corresponding hand, the game ends in a tie. Further, when both the player's five-card hand and two-card hand rank as high as the dealer's respective corresponding hands, the dealer wins. It is to be noted that, as the five-card hand, there are Royal Flush, Straight Flush, Four of a Kind, Full House, Flush, Straight, Three of a Kind, Two Pair, One Pair, and No Pair, in order of strength. As the two-card hand, there are One Pair and No Pair in order of strength.

In the following embodiment, Pai Gow Poker accepting a normal BET and a side BET is executed. Here, the normal BET is a BET placed on winning or losing in Pai Gow Poker, and the side BET is a BET placed for receiving an offer of a special payout when a specific card (hereinafter also referred to as a payout card) is included in the player's cards (BET on a side game). Part of the side-bet game media is cumulatively accumulated as a jackpot (hereinafter also referred to as a JP), and the JP is offered as the special payout.

Further, the payout card is determined in each play of the game.

### FIRST EMBODIMENT

In a first embodiment, the side BET is placed in the normal game, and when the payout card determined in each normal game is included in the player's cards, the JP (special payout) is offered.

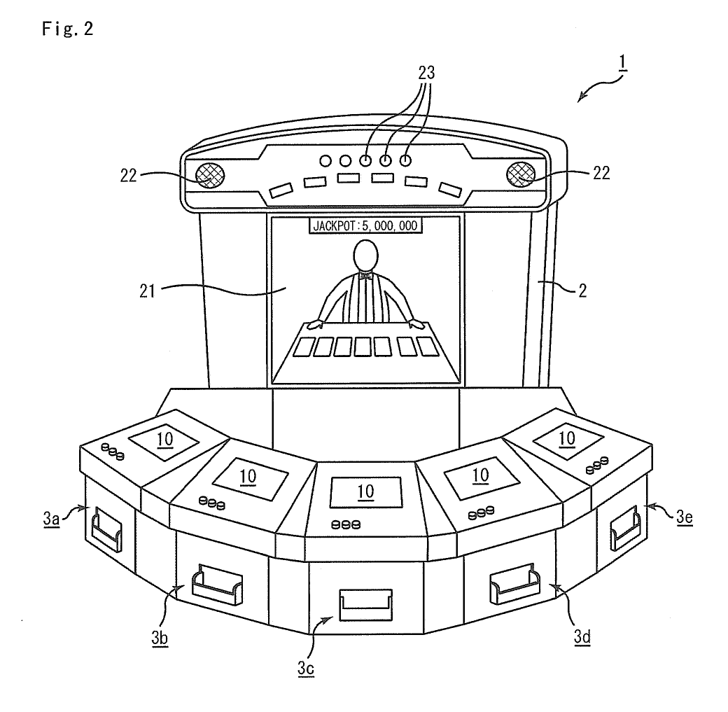

First, processing executed by a station 3 (see FIG. 2) in a gaming machine 1 according to the present embodiment is described.

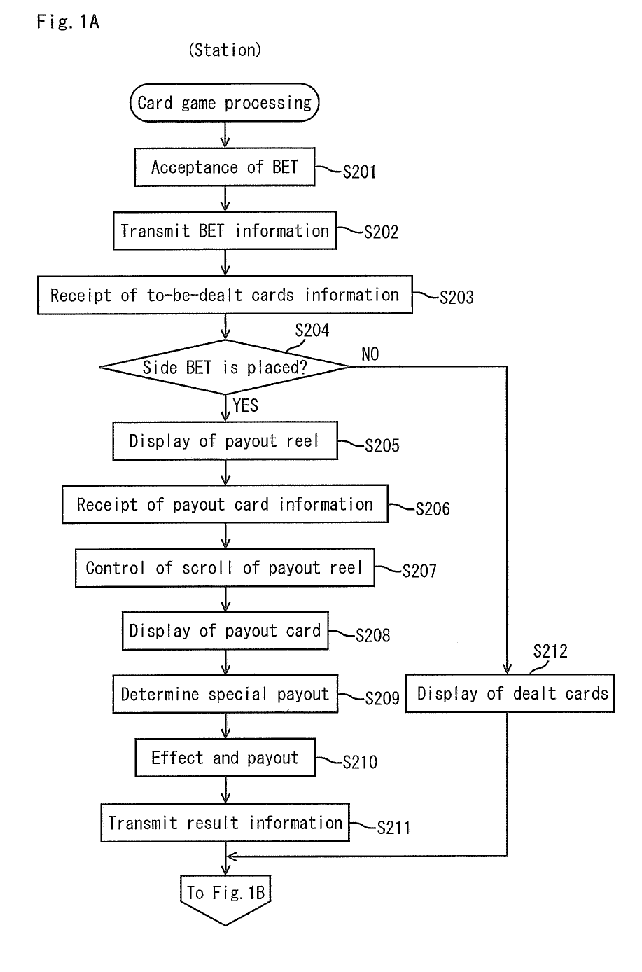

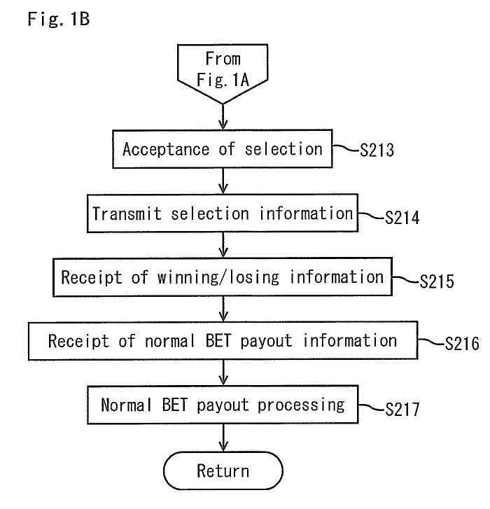

FIG. 1A and FIG. 1B are flowcharts each showing card game processing executed in a station provided in a gaming machine according to the first embodiment of the present invention.

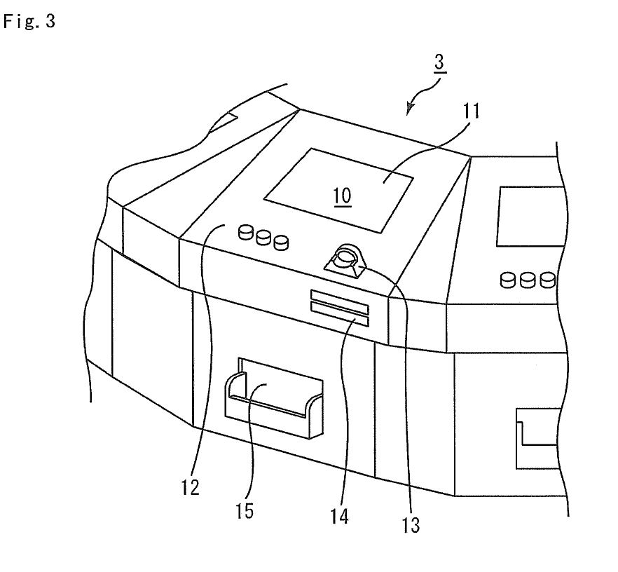

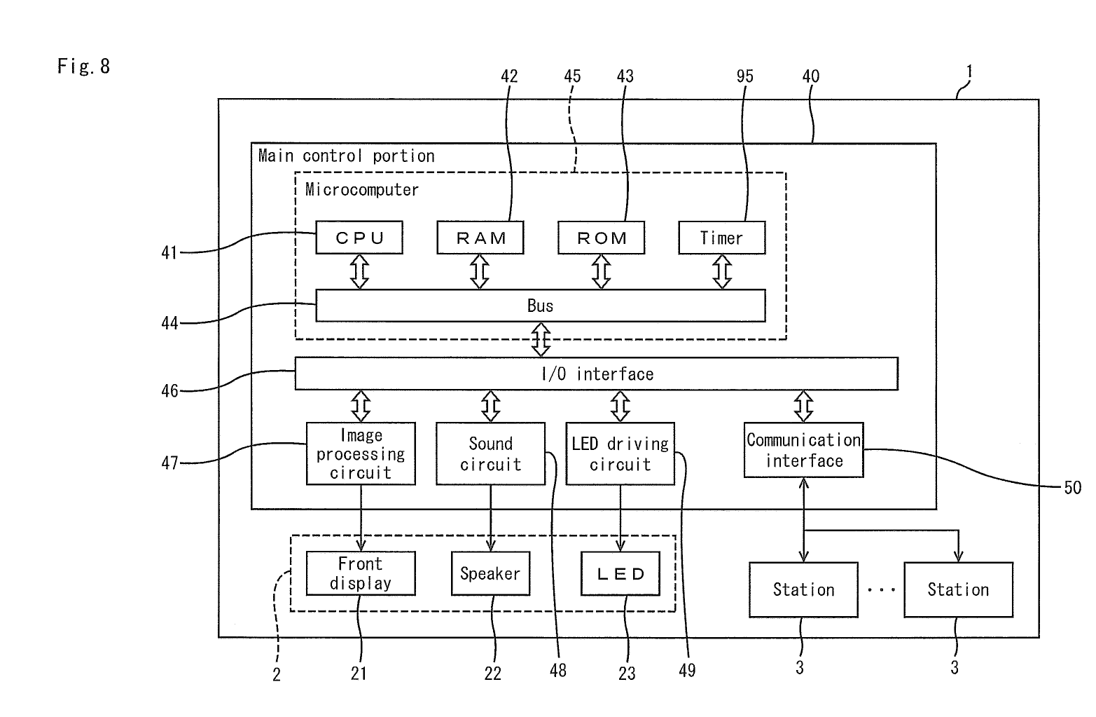

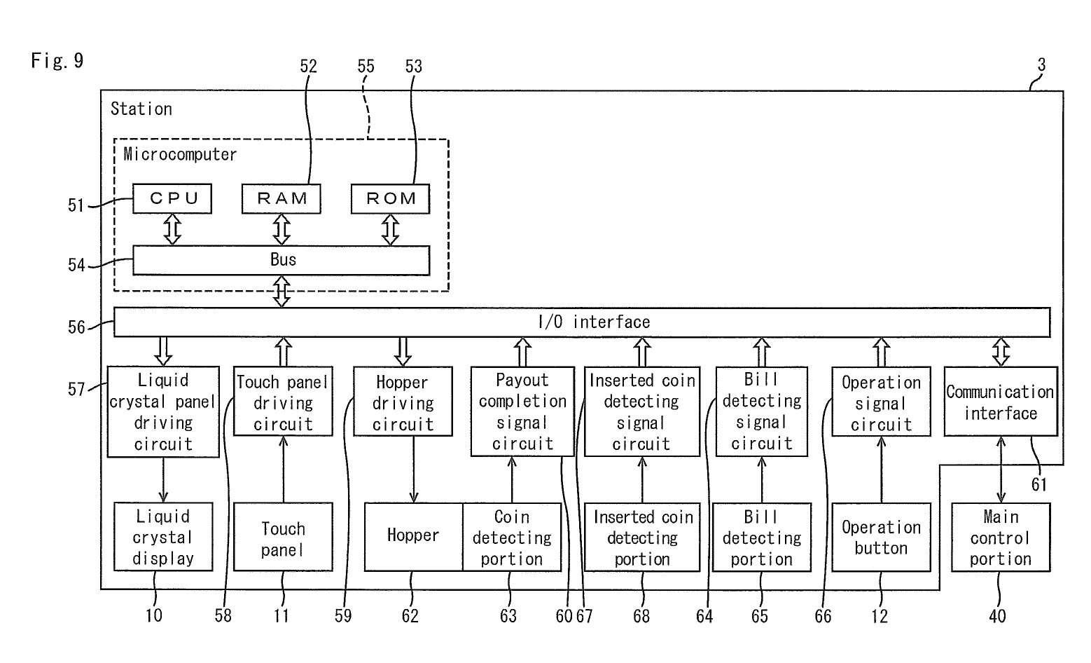

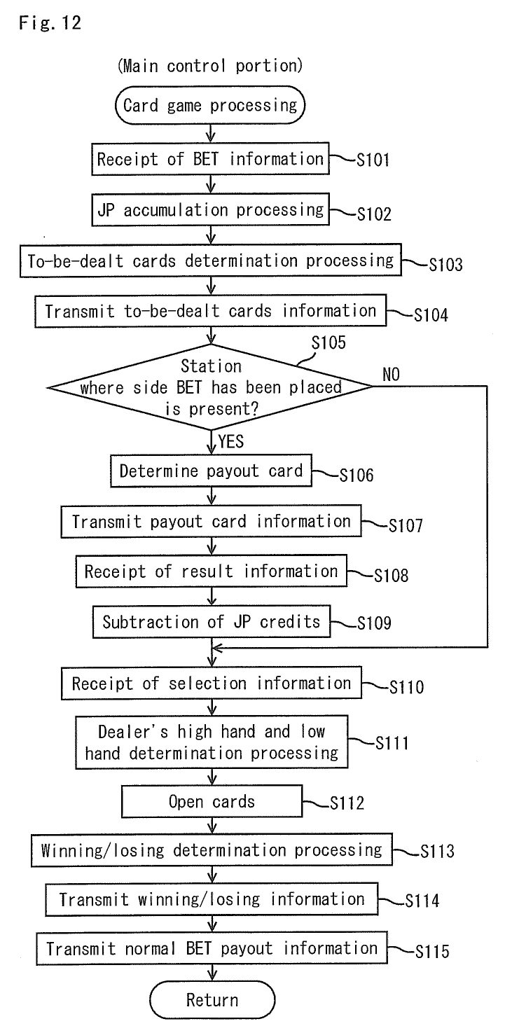

First, a CPU 51 (see FIG. 9) in the station 3 transmits to a main control portion 40 (see FIG. 8) a signal indicating that Pai Gow Poker is to be played, upon detection of contact from a touch panel 11 (see FIG. 3) or receipt of a signal indicating detection of coin insertion from an inserted coin detecting portion 68 (see FIG. 9). Thereby, in the main control portion 40, card game processing that is described later using FIG. 12 proceeds.

In step S201 in FIG. 1A, the CPU 51 accepts input of a normal BET and a side BET. This enables the player to input a normal BET and a side BET via the touch panel 11 in the station 3.

Next, in step S202, the CPU 51 transmits BET information as information on the inputted BET to the main control portion 40. The BET information includes information showing whether or not the normal BET and the side BET have been placed and information showing amounts of a normal BET and a side BET. Upon receipt of the BET information, the main control portion 40 determines cards to be dealt to the player and the dealer (see step S103 in FIG. 12).

Next, in step S203, the CPU 51 receives to-be-dealt cards information showing cards to be dealt to the player and the dealer, from the main control portion 40.

Next, in step S204, the CPU 51 determines whether or not the side BET has been placed in step S201.

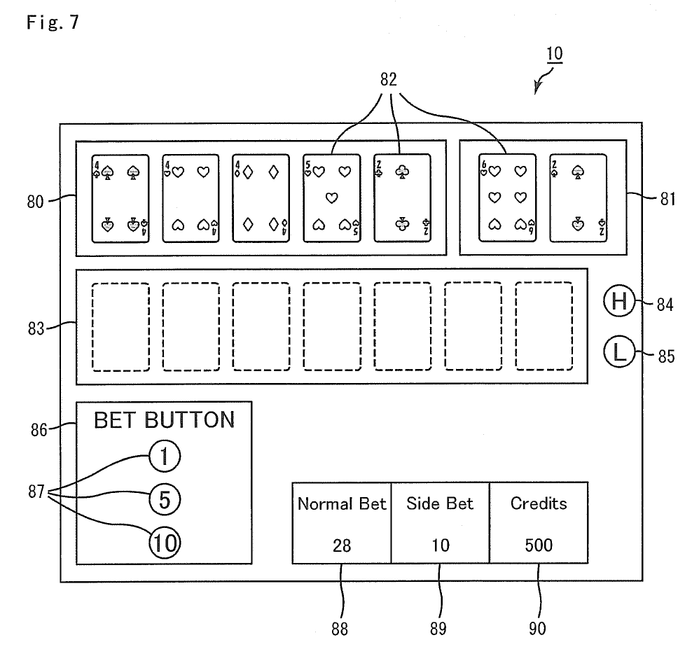

When determining that the side BET has not been placed, the CPU 51 displays card images showing seven player's cards in a dealt card display portion 83 (see FIG. 7) of a liquid crystal display 10 based on the to-be-dealt cards information received in step S203 (step S212), and proceeds with the processing to step S213.

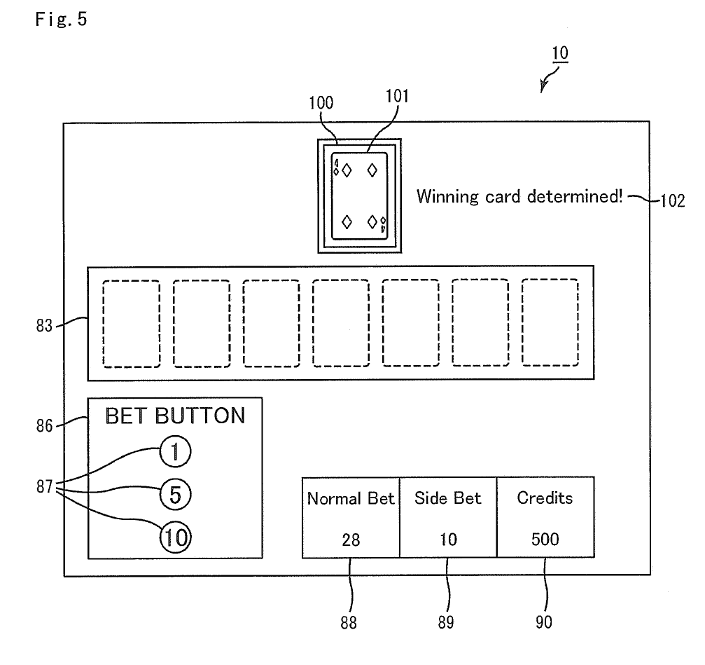

On the other hand, when determining in step S204 that the side BET has been placed, the CPU 51 displays in step S205 a payout reel (see image 100 in FIG. 5) for determining the payout card (specific card) to the liquid crystal display 10.

A game played during a period of executing the processing of step S205 to S211 is a side game.

Next, in step S206, the CPU 51 receives payout card information from the main control portion 40. The payout card information is information showing a result of a determination of the payout card.

Next, in step S207, the CPU 51 scroll-displays the payout reel, and then displays the payout card shown by the payout card information received in step S206 (see card image 101 in FIG. 5).

Next, in step S208, the CPU 51 displays card images showing seven player's cards to the dealt card display portion 83 of the liquid crystal display 10 based on the to-be-dealt cards information received in step S203.

Next, in step S209, the CPU 51 determines whether or not the payout card is included in the player's cards displayed in step S208, and determines whether or not to offer the JP (special payout). Specifically, the CPU 51 determines to offer the JP when the payout card is included in the player's cards.

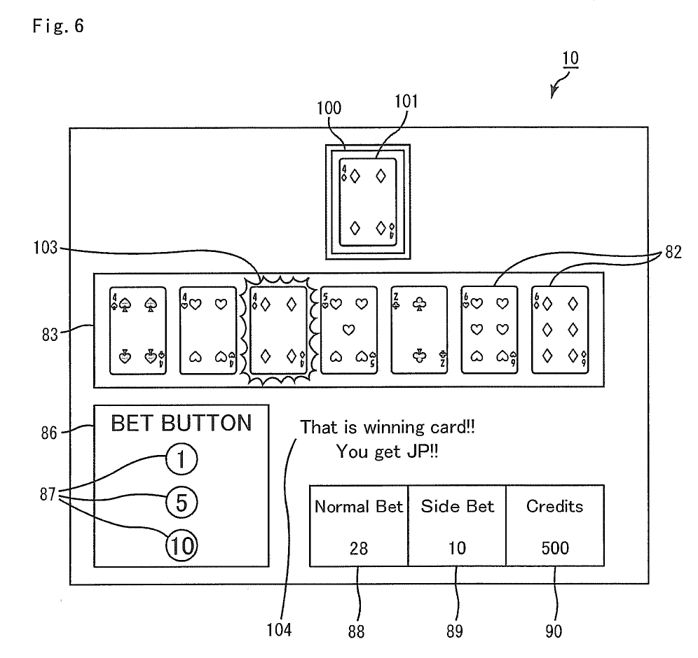

Next, in step S210, the CPU 51 performs the effect of notifying a result of the side game for determining whether or not the payout card is included in the player's cards (see FIG. 6), and pays out coins corresponding to the JP when determining to offer the JP in step S209.

Next, in step S211, the CPU 51 transmits result information to the main control portion 40. The result information is information showing an amount of the JP offered in the side game.

Next, in step S213 in FIG. 1B, the CPU 51 accepts input for selecting a high hand and a low hand. This enables the player to operate a high hand determination button 84 and a low hand determination button 85 (see FIG. 7) via the touch panel 11 so as to determine a high hand and a low hand out of the dealt cards.

Next, in step S214, the CPU 51 transmits selection information based on selection of the high hand and the low hand, to the main control portion 40. Upon receipt of the selection information, the main control portion 40 determines a high hand and a low hand of the dealer's cards, and executes processing of determining winning or losing (step S113 in FIG. 12).

Next, in step S215, the CPU 51 receives winning/losing information from the main control portion 40. Subsequently, based on the received winning/losing information, the CPU 51 displays an image showing any one of “You won”, “You lost”, or “Tie” to the dealt card display portion 83 of the liquid crystal display 10 for a predetermined period (10 seconds in the present embodiment).

Next, in step S216, the CPU 51 receives normal BET payout information from the main control portion 40. Upon receipt of the normal BET payout information, the CPU 51 stores credit data based on the normal BET payout information into a RAM 52.

Next, in step S217, the CPU 51 pays out credits based on the normal BET payout information received in step S216. Processing of paying out credits based on the normal BET payout information from the main control portion 40 corresponds to the processing of offering the normal payout in the present invention.

After executing the processing of step S217, the CPU 51 completes the present subroutine.

It is to be noted that a game played during a period in which the processing of steps S201 to S204 and steps S212 to S217 are executed corresponds to the normal game in the present invention.

Next, the gaming machine 1 according to the present embodiment is described.

FIG. 2 is a perspective view schematically showing an appearance configuration of the gaming machine according to the first embodiment of the present invention.

As shown in FIG. 2, the gaming machine 1 basically includes a main monitor 2 and five stations 3 (stations 3a to 3e). It is to be noted that, although the case of the gaming machine 1 including a plurality of (five) stations 3 in the present embodiment, the gaming machine may include only one station in the present invention.

A front display 21 is provided at the central portion of the main monitor 2 to which images showing a dealer, cards and the amount of the JP are displayed. The front display 21 corresponds to the display of the present invention. Above the main monitor 2, there are provided: speakers 22 that output music or an effect sound in accordance with progress of a game being executed on the gaming machine 1; and LEDs 23 lighted at times of a variety of effects.

FIG. 3 is a perspective view schematically showing an appearance configuration of the station in the gaming machine shown in FIG. 2.

As shown in FIG. 3, the later-described liquid crystal display 10 that displays images regarding operations (see FIGS. 5 to 7) and the like is provided at the center of the upper surface of the station 3. The liquid crystal display 10 corresponds to the display of the present invention. Further, the touch panel 11 for inputting operations for placing a BET and the like are provided on the upper surface of the liquid crystal display 10. The touch panel 11 corresponds to the input device in the present invention.

In front of the liquid crystal display 10 are provided operation buttons 12 for performing a payout operation and a coin insertion slot 13 into which coins or medals are inserted.

On the upper right end of the front surface of the station 3, there is provided a bill insertion slot 14 into which a bill is inserted. Below the bill insertion slot 14 is provided a coin payout exit 15, from which coins or medals corresponding to the accumulated credits are paid out to the player when the payout operation is performed.

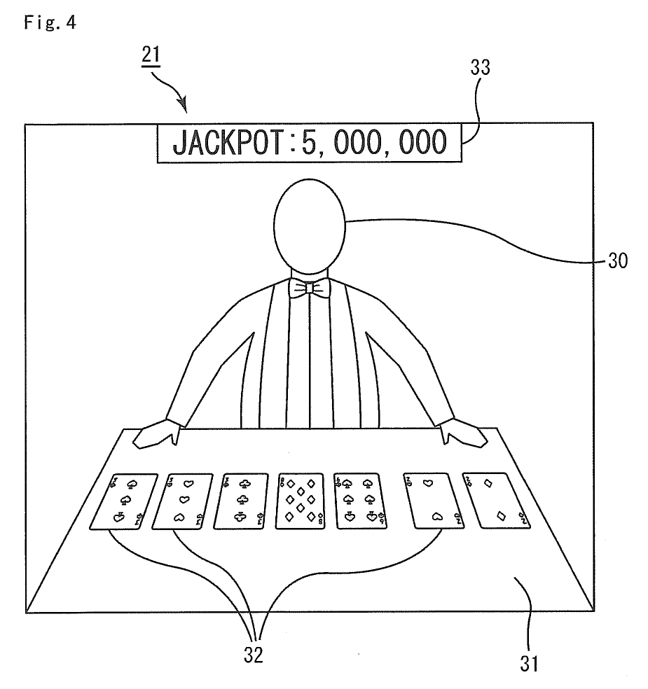

FIG. 4 is a view showing an example of images displayed to the front display in the gaming machine.

As shown in FIG. 4, a JP display portion 33 for displaying an amount of a JP is provided on the upper side of the front display 21. Further, a dealer image 30 that shows a dealer, a table image 31 that shows a table, and card images 32 that show seven dealer's cards are displayed to the front display 21. The card images 32 are displayed face down when the cards are dealt to the dealer. When the high hand and the low hand are determined, the card images 32 are displayed face up. When facing to FIG. 4, the five cards on the left side show the high hand and the two cards on the right side show the low hand.

FIGS. 5 to 7 are views each showing an example of images displayed to a liquid crystal display provided in the station in the first embodiment.

FIG. 5 shows an example of images displayed when the side BET is placed.

On the upper side of the liquid crystal display 10, the image 100 is displayed which shows the payout reel for determining the payout card in the side game. The card image 100 includes the card image 101 showing the payout card in the side game. The payout reel shown by the image 100 is scrolled at the start of the side game, and the card image 101 showing the payout card is displayed after a lapse of predetermined time. In the example shown in FIG. 5, the payout card is a “4 of Diamond” card.

To the right of the image 100, an image 102 is displayed which notifies that the payout card has been determined.

Below the image 100 and the image 102, the dealt card display portion 83 is provided. After the payout card is determined, card images showing the seven player's cards dealt to the player are displayed in seven parts surrounded by dotted lines in the dealt card display portion 83.

A BET button display portion 86 is provided under the dealt card display portion 83. BET buttons 87 for inputting the number of BETs is displayed in the BET button display portion 86. The player operates the BET buttons 87 via the touch panel 11, so as to input the number of normal BETs and the number of side BETs.

To the right of the BET button display portion 86, a number-of-normal-BETs display portion 88 that displays the number of normal-bet coins is provided. FIG. 5 shows that 28 coins have been bet. It is to be noted that in the case of inputting a BET of 28 coins, the player may operate the BET button 87 “10” twice, the BET button 87 “5” once, and the BET button 87 “1” three times.

To the right of the number-of-normal-BETs display portion 88, a number-of-side-BETs display portion 89 that displays the number of side-bet coins is provided. FIG. 5 shows that 10 coins have been bet.

To the right of the number-of-side-BETs display portion 89, a number-of-credits display portion 90 is provided. FIG. 5 shows that 500 coins have been credited.

FIG. 6 shows an example of images displayed when the player's cards are displayed in the side game.

In the dealt card display portion 83, card images showing the seven player's cards dealt to the player are displayed face up. In the example of FIG. 6, since the “4 of Diamond” card as the specific card is included in the player's cards, an image 103 indicating that the payout card is included in the player's cards is displayed around the payout card. Further, below the dealt card display portion 83, an image 104 is displayed which notifies that the payout card is included in the player's cards and the JP will be offered.

FIG. 7 shows an example of images displayed when the side BET is not placed, or when the high-hand and the low-hand are selected by the player after completion of the side game.

As shown in FIG. 7, a high hand display portion 80 that displays the high hand of the player and a low hand display portion 81 that displays the low hand of the player are provided on the upper side of the liquid crystal display 10. In the high hand display portion 80 and the low hand display portion 81, card images 82 respectively showing the high-hand cards and the low-hand cards are displayed face up. The dealt card display portion 83 is provided below the high hand display portion 80. The high hand determination button 84 and the low hand determination button 85 for determining cards constituting the high hand and the low hand are provided to the right of the dealt card display portion 83. The player selects cards with which he or she wishes to create the high hand out of the cards displayed in the dealt card display portion 83, via the touch panel 11, and operates the high hand determination button 84 via the touch panel 11, so as to determine the high hand. The cards determined as the high hand are displayed in the high hand display portion 80. Similarly, the player selects cards with which he or she wishes to create the low hand out of the cards displayed in the dealt card display portion 83, via the touch panel 11, and operates the low hand determination button 85 via the touch panel 11, so as to determine the low hand.

FIG. 8 is a block diagram showing an internal configuration of the gaming machine shown in FIG. 2.

As shown in FIG. 8, the main control portion 40 in the gaming machine 1 has a microcomputer 45 as the core, which basically includes a CPU 41, a RAM 42, a ROM 43, a timer 95, and a bus 44 that is for mutually transmitting data thereamong. The main control portion 40 corresponds to the controller in the present invention.

The ROM 43 stores a variety of programs for performing processing necessary in controlling the gaming machine 1, a data table, and the like. The RAM 42 is a memory that temporarily stores a variety of data calculated in the CPU 41. Further, the RAM 42 stores as credit data an amount of a JP comprising part of side-BET credits cumulatively added.

Moreover, the timer 95 performs time measurement.

Furthermore, the CPU 41 is connected, through an I/O interface 46, to an image processing circuit 47, a sound circuit 48, an LED driving circuit 49, and a communication interface 50.

The image processing circuit 47 is connected with the front display 21 forming the main monitor 2; the sound circuit 48 is connected with the speakers 22 forming the main monitor 2; and the LED driving circuit 49 is connected with the LEDs 23 forming the main monitor 2. The communication interface 50 is connected with five stations 3.

The CPU 41 proceeds with games (Pai Gow Poker and the side game) that progress on the gaming machine 1, based on game programs (including game programs for Pai Gow Poker and the side game) stored in the ROM 43 and on a variety of signals received from the stations 3. Further, based on the game programs, the CPU 41 displays an image to the front display 21, outputs a sound from the speakers 22, and lights the LEDs 23. Moreover, the CPU 41 transmits a variety of signals to the respective stations 3 based on the game programs.

FIG. 9 is a block diagram showing an internal configuration of the station in the gaming machine shown in FIG. 2.

As shown in FIG. 9, the station 3 has a microcomputer 55 as the core, which basically includes the CPU 51, the RAM 52, a ROM 53, and a bus 54 that is for mutually transmitting data thereamong.

The ROM 53 stores a variety of programs for performing processing necessary in controlling the station 3, a data table, and the like. Further, the RAM 52 temporarily stores the number of credits currently accumulated in the station 3 and a variety of data calculated in the CPU 51.

Moreover, the CPU 51 is connected, through an I/O interface 56, to a liquid crystal panel driving circuit 57, a touch panel driving circuit 58, a hopper driving circuit 59, a payout completion signal circuit 60, an inserted coin detecting signal circuit 67, a bill detecting signal circuit 64, an operation signal circuit 66, and a communication interface 61.

The liquid crystal panel driving circuit 57 is connected with the liquid crystal display 10, the touch panel driving circuit 58 is connected with the touch panel 11, the hopper driving circuit 59 is connected with a hopper 62, the payout completion signal circuit 60 is connected with the coin detecting portion 63, the inserted coin detecting signal circuit 67 is connected with the inserted coin detecting portion 68, the bill detecting signal circuit 64 is connected with a bill detecting portion 65, and the operation signal circuit 66 is connected with the operation buttons 12.

The hopper 62 is provided inside the station 3, and pays out coins from the coin payout exit 15 based on a control signal outputted from the CPU 51.

The coin detecting portion 63 is provided inside the coin payout exit 15, and transmits a signal to the CPU 51 when detecting that coins in a predetermined number have been paid out from the coin payout exit 15.

When detecting insertion of coins from the coin insertion slot 13, the inserted coin detecting portion 68 detects the amount of the coins, and transmits a detecting signal showing the detected amount to the CPU 51. The detected coins are stored in the RAM 52, with a predetermined amount as one credit.

The bill detecting portion 65 detects an amount of a bill when receiving the bill, and transmits a signal showing the detected amount to the CPU 51. The detected bill is stored in the RAM 52, with a predetermined amount as one credit.

The operation buttons 12 are buttons for performing the payout operation when payout of coins is determined.

Next, processing performed in the main control portion 40 and the station 3 is described.

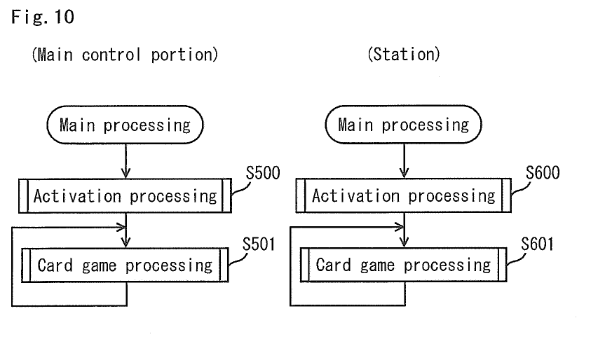

FIG. 10 is a flowchart showing main processing performed in the main control portion and the station.

The following main processing is performed in the main control portion 40.

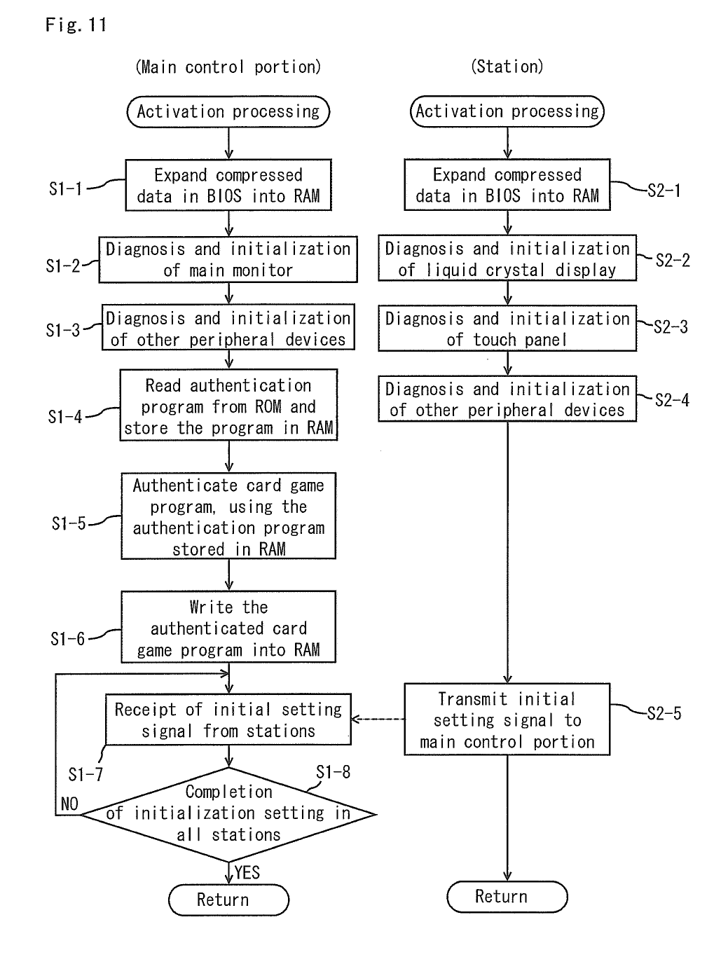

The CPU 41 of the main control portion 40 executes activation processing (step S500). The activation processing performed in step S500 is described later using FIG. 11. After executing the activation processing, the CPU 41 executes card game processing (step S501). The card game processing executed in step S501 is described later using FIG. 12.

Meanwhile, the following main processing is performed in the station 3.

The CPU 51 of the station 3 executes activation processing (step S600). The activation processing performed in step S600 is described later using FIG. 11. After executing the activation processing, the CPU 51 executes card game processing (step S601). The card game processing executed in step S601 is the processing that has been described using FIG. 1A and FIG. 1B.

FIG. 11 is a flowchart showing a procedure of the activation processing.

This activation processing is processing performed in the main control portion 40 and the station 3, as triggered by power-on (see step S500 and step S600 in FIG. 10).

At power-on, first, the CPU 41 of the main control portion 40 executes a BIOS stored in the ROM 43, and expands compressed data incorporated in the BIOS into the RAM 42 (step S1-1). The CPU 41 then executes the BIOS expanded into the RAM 42, and diagnoses and initializes a variety of peripheral devices.

Specifically, the CPU 41 diagnoses and initializes the main monitor 2 (step S1-2). In this processing, the CPU 41 transmits a request signal to the main monitor 2 and determines whether or not to have received a predetermined response signal, and conducts clearance of a predetermined storage region, and the like.

Next, the CPU 41 diagnoses and initializes the other peripheral devices connected to the CPU 41 (step S1-3).

Next, the CPU 41 reads an authentication program stored in the ROM 43, and also performs processing of storing the read authentication program into the RAM 42 (step S1-4). At this time, the CPU 41 obtains a checksum by ADDSUM system (standard checking function) in accordance with the standard BIOS function of the BIOS, and stores the authentication program into the RAM 42 while performing processing of checking whether or not the storage is performed without an error.

Next, the CPU 41 reads the card game program from the ROM 43. In this case, the CPU 41 reads data constituting the card game program by four bytes at a time. Subsequently, the CPU 41 performs authentication for checking and verifying that the read authentication program is authentic (not broken) in accordance with the authentication program stored in the RAM 42 (step S1-5). When properly completing this authentication processing, the CPU 41 writes and stores the card game program having been an object to be authenticated (having been authenticated) into the RAM 42 (step S1-6).

Meanwhile, the CPU 51 of the station 3 first executes a BIOS stored in the ROM 53, and expands compressed data incorporated in the BIOS into the RAM 52 (step S2-1). The CPU 51 then executes the BIOS expanded into the RAM 52 and diagnoses and initializes a variety of peripheral devices.

Specifically, the CPU 51 diagnoses and initializes the liquid crystal display 10 (step S2-2). In this processing, the CPU 51 transmits a request signal to the liquid crystal panel driving circuit 57, and determines whether or not to have received a predetermined response signal.

Next, the CPU 51 diagnoses and initializes the touch panel 11 (step S2-3). In this processing, the CPU 51 transmits a request signal to the touch panel 11, and determines whether or not to have received a predetermined response signal.

Next, the CPU 51 diagnoses and initializes the other peripheral devices connected to the CPU 51 (step S2-4).

Next, the CPU 51 transmits an initial setting signal to the main control portion 40 (step S2-5). The initial setting signal is a signal showing completion of diagnosis and initialization of the variety of peripheral devices in the station 3.

After executing the processing of step S2-5, the CPU 51 completes the present subroutine.

The CPU 41 of the main control portion 40 receives the initial setting signal transmitted by the station 3 in step S2-5 (step S1-7). Subsequently, the CPU 41 determines whether or not to have received the initial setting signals from all the stations 3 (step S1-8).

When determining that the initial setting signal has not been received from some station 3, the CPU 41 returns the processing to step S1-7. On the other hand, when determining that the initial setting signals have been received from all the stations 3, the CPU 41 completes the present subroutine.

Next, the card game processing performed on the gaming machine 1 is described. However, since the processing performed in the station 3 has already been described in FIG. 1A and FIG. 1B, only processing performed in the main control portion 40 is described here.

FIG. 12 is a flowchart showing card game processing executed in the main control portion in the gaming machine according to the first embodiment of the present invention.

First, in step S101, the CPU 41 in the main control portion 40 receives BET information from the station 3.

Next, in step S102, the CPU 41 cumulatively stores 50% of side-BET credits, as a JP, based on the BET information received in step S101.

Next, in step S103, the CPU 41 determines seven cards each to be dealt to the player and the dealer, out of a deck of playing cards, by means of random numbers. The seven cards determined to be dealt to the player in step S103 correspond to the player's cards of the present invention, and the seven cards determined to be dealt to the dealer in step S103 correspond to the dealer's cards of the present invention.

Next, in step S104, the CPU 41 transmits to-be-dealt cards information to the station 3. The to-be-dealt cards information includes information showing types (ranks and suits: Hearts, Clubs, Spades, Diamonds) of the cards determined to be dealt to the player and the dealer.

Next, in step S105, the CPU 41 determines whether or not the station 3 where the side BET has been placed is present based on the BET information received in step S101.

When determining that the station 3 where the side BET has been placed is not present, the CPU 41 shifts the processing to step S110.

On the other hand, when determining that the station 3, where the side BET has been placed is present, the CPU 41 determines the payout card in the side game in step S106. Specifically, the CPU 41 determines one card as the payout card out of a deck of playing cards by means of a random number.

It is to be noted that the payout card may be determined so as to be different among each station 3 where the side BET has been placed.

Next, in step S107, the CPU 41 transmits payout card information showing a result of the determination of the payout card in step S106 to the station 3 where the side BET has been placed.

Next, in step S108, the CPU 41 receives result information showing the amount of JP offered in the side game from the station 3 where the side BET has been placed.

Next, in step S109, the CPU 41 subtracts credits in amount shown by the result information received in step S108 from credits of the JP stored in the RAM 43.

Next, in step S110, the CPU 41 receives selection information from the station 3. The selection information is information showing which card is selected to be in the high hand and which card is selected to be in the low hand.

Next, in step Sill, the CPU 41 executes processing of dividing the cards dealt to the dealer into the high hand and the low hand.

Next, in step S112, the CPU 41 displays card images showing the high hand and the low hand determined in step S111 face up to the front display 21.

Next, in step S113, the CPU 41 executes processing of determining winning or losing based on the selection information received in step S110 and on the high hand and the low hand determined in step S111. Specifically, the CPU 41 compares the ranks of the player's high hand and the dealer's high hand so as to determine which is higher, and compares the ranks of the player's low hand and the dealer's low hand so as to determine which is higher; based on these determination results, winning or losing is determined. More specifically, the player wins when the player's high hand ranks higher than the dealer's high hand and the player's low hand ranks higher than the dealer's low hand. The dealer wins when the dealer's high hand ranks higher than the player's high hand and the dealer's low hand ranks higher than the player's low hand. The game is tied when one of the player's hands ranks higher than the dealer's corresponding hand and the other of the dealer's hands ranks higher than the player's corresponding hand.

Next, in step S114, the CPU 41 transmits information showing winning or losing determined in step S113 (hereinafter also referred to as “winning/losing information”) to the station 3. In the station 3, when the winning/losing information is received, any one of images “Yon won”, “You lost” and “Tie” is displayed to the liquid crystal display 10, based on the winning/losing information.

Next, in step S115, the CPU 41 transmits normal BET payout information to the station 3. The normal BET payout information is information showing an amount of credits (currency value) to be paid out with respect to the normal BET. Specifically, the CPU 41 transmits information showing credits in amount twice as large as the amount of the normal BET when the player wins, and transmits information showing credits in the same amount as the amount of the normal BET when the game is tied. Further, when the dealer wins, the CPU 41 transmits information showing that the amount of credits to be offered is 0.

After executing the processing of step S115, the CPU 41 completes the present subroutine.

As above described, the gaming machine 1 according to the first embodiment comprises the front display 21 and the liquid crystal display 10 (display) each capable of displaying a plurality of cards; the touch panel 11 (input device); and the main control portion 40 (controller). The main control portion 40 is programmed so as to execute the processing of (a) accepting a normal BET from the touch panel 11, (b) accepting a side BET different from the normal BET, from the touch panel 11, (c) cumulatively accumulating a predetermined percentage of game media side-bet from the touch panel 11, (d) displaying player's cards and dealer's cards respectively to the liquid crystal display 10 and the front display 21, (e) executing a normal game for determining winning or losing based on the player's cards and the dealer's cards, (f) offering a normal payout based on the normal BET when determining that a player has won in the normal game, (g) determining whether or not a specific card is included in the player's cards when the side BET has been placed, and (h) offering a special payout from the game media cumulatively accumulated in the processing (c), when determining in the processing (g) that the specific card is included in the player's cards.

According to the gaming machine 1, since a side game (game for determining whether or not the specific card is included) is played using the player's cards dealt in a normal game, a player interested in the normal game tends not to have a sense of resistance toward placing the side BET. Further, since a new gaming property of determining whether or not the specific card is included is added, an interesting aspect of the game itself can be further enhanced.

Moreover, since the special payout is offered when the specific card is included in the side game, it is possible to increase a sense of anticipation of the player for the side game (special payout).

Further, since the special payout is part of the side-bet game media cumulatively accumulated, it is possible for the player to acquire a payout in a large amount in the side game.

Accordingly, it is possible to make the player have a high motivation to place the side BET.

### SECOND EMBODIMENT

Next, a gaming machine according to a second embodiment is described. It is to be noted that constituents corresponding to those of the gaming machine 1 according to the first embodiment are described as provided with the same symbols.

There has been described the case of determining the payout card in the side game by means of a random number in the first embodiment, but in the second embodiment, there is described the case of determining the payout card by an input from the player.

Since the gaming machine according to the second embodiment has an appearance, circuit configuration, and the like, which are similar to those of the gaming machine 1 according to the first embodiment, the descriptions thereof are omitted here. In the following, images displayed to the liquid crystal display 10, and card game processing executed in the main control portion 40 and the station 3 are described.

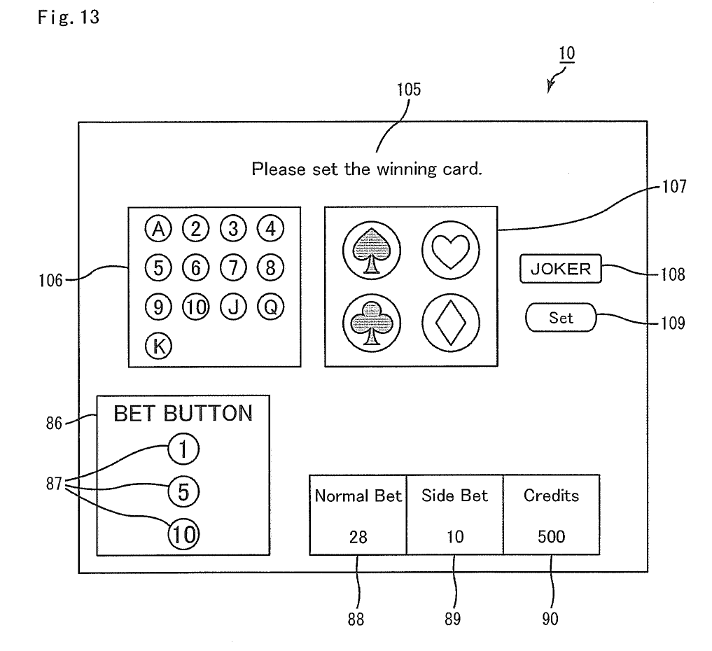

FIG. 13 is a view showing an example of images displayed to the liquid crystal display provided in the station where the side BET has been placed in the second embodiment.

When the side BET is placed, a payout card selection screen is displayed.

Specifically, as shown in FIG. 13, on the upper side of the liquid crystal display 10, an image 105 for prompting the player to determine the payout card is displayed, and below the image 105, a selection button display portion 106 for selecting a number or an alphabet (rank) of the payout card and a selection button display portion 107 for selecting a suit (Heart, Club, Spade, Diamond) of the payout card are displayed. Further, to the right of the selection button display portion 107, a Joker selection button 108 for selecting “Joker” as the payout card, and a set button 109 for determining the selected card as the payout card.

After selecting a number or an alphabet from the selection button display portion 106 through the touch panel 11 and then selecting a suit from the selection button display portion 107, the player can press the set button 109, to determine a payout card. Further, the player can press the set button 109 after pressing the Joker selection button 108, to determine “Joker” as the payout card.

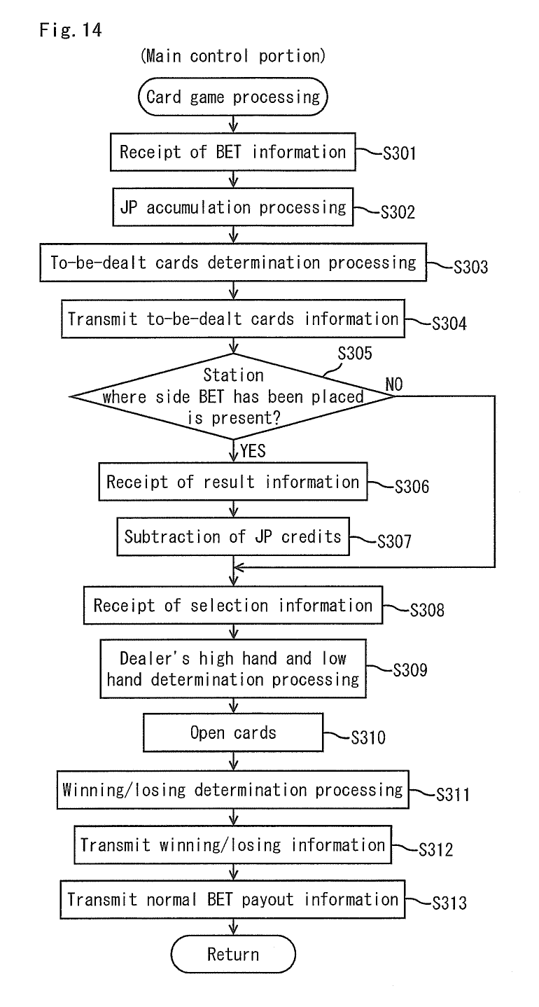

FIG. 14 is a flowchart showing card game processing executed in the main control portion provided in the gaming machine according to the second embodiment.

Since processing of steps S301 to S304 in FIG. 14 is similar to the processing of steps S101 to S104 in FIG. 12 in the first embodiment, the description thereof is omitted here.

In step S305, the CPU 41 determines whether or not the station 3 where the side BET has been placed is present, based on the BET information received in step S301. When determining that the station 3 where the side BET has been placed is not present, the CPU 41 shifts the processing to step S308.

On the other hand, when determining that the station 3 where the side BET has been placed is present, the CPU 41 receives in step S306 result information showing the amount of JP offered in the side game, from the station where the side BET has been placed.

Next, in step S307, the CPU 41 subtracts credits in amount shown by the result information received in step S306 from the credits of the JP stored in the RAM 43.

Since processing of subsequent steps S308 to S313 is similar to the processing of steps S110 to S115 in FIG. 12 in the first embodiment, the description thereof is omitted here.

After execution of the processing of step S313, the present subroutine is completed.

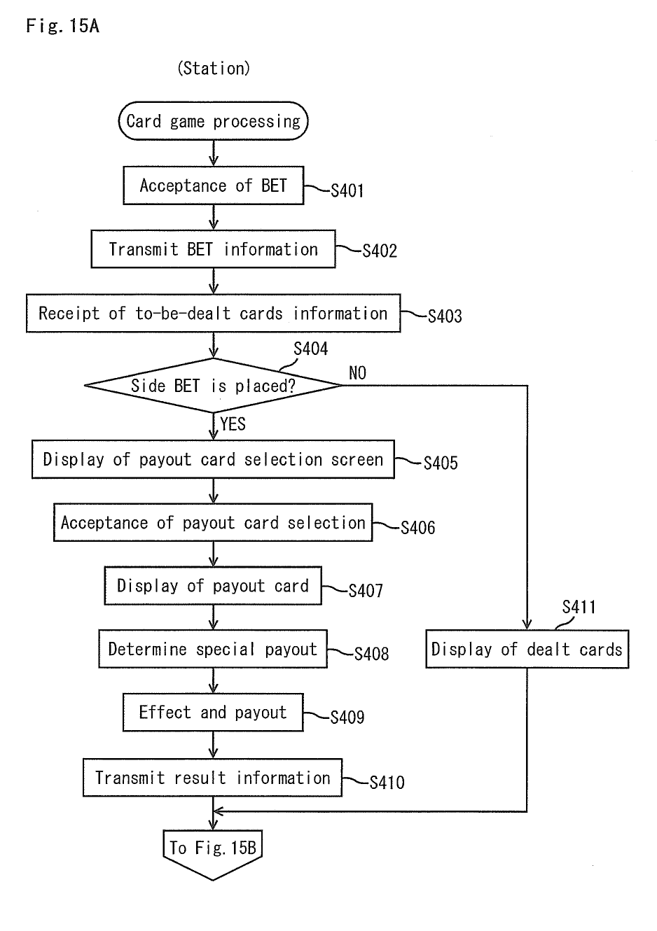

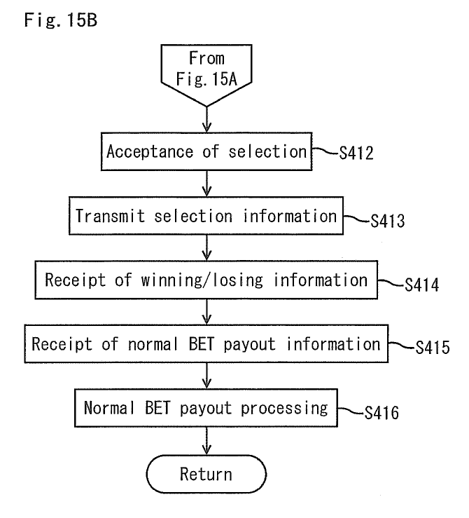

FIG. 15A and FIG. 15B are flowcharts each showing a subroutine of card game processing executed in the station according to the second embodiment.

Since the processing of steps S401 to S403 in FIG. 15A are similar to the processing of steps S201 to S203 in FIG. 1A in the first embodiment, the description thereof is omitted here.

Next, in step S404, the CPU 51 determines whether or not the side BET has been placed in step S401.

When determining that the side BET has not been placed, the CPU 51 displays card images showing seven player's cards in the dealt card display portion 83 of the liquid crystal display 10 based on the dealt card information received in step S403 (step S411), and proceeds with the processing to step S412.

On the other hand, when determining in step S404 that the side BET has been placed, the CPU 51 displays in step S405 a selection screen for determining the payout card (specific card) to the liquid crystal display 10 (see FIG. 13).

Next, in step S406, the CPU 51 accepts a selection of the payout card by the player through the touch panel 11.

Next, in step S407, the CPU 51 displays card images showing seven player's cards in the dealt card display portion 83 of the liquid crystal display 10 based on the to-be-dealt cards information received in step S403.

Next, in step S408, the CPU 51 determines whether or not the payout card selected in step S406 is included in the player's cards displayed in step S407, and determines whether or not to offer the JP (special payout). Specifically, the CPU 51 determines to offer the JP when the payout card is included in the player's cards.

Next, in step S409, the CPU 51 performs the effect of notifying the result of the side game for determining whether or not the payout card is included in the player's cards, and pays out coins corresponding to the JP when determining to offer the JP in step S408.

Next, in step S410, the CPU 51 transmits result information to the main control portion 40. The result information is information showing the amount of the JP offered in the side game.

Since processing of subsequent steps S412 to S416 in FIG. 15B is similar to the processing of steps S213 to S217 in FIG. 1B in the first embodiment, the description thereof is omitted here.

After execution of the processing of step S416, the present subroutine is completed.

As above described, according to the gaming machine 1 of the second embodiment, since the payout card is not a fixed card previously determined, but a card determined by an input of the player in each game, it is possible to make the player strongly aware of being participating in the side game, in addition to enhancing the game properties of the side game so as to increase a sense of anticipation of the player for the special payout.

In the first and second embodiments, the case of determining the payout card in each play of the side game has been described, but in the present invention, the specific card may be a card previously determined. Further, the specific cards may include a plurality of cards.

Further, in the first and second embodiments, the case has been described where the special payout is the JP comprising part of the side-bet game media cumulatively accumulated, but the special payout in the present invention may be a predetermined amount of game media.

Further, in the first and second embodiments, the case of playing Pai Gow Poker as the normal game has been described. However, in the present invention, the game is not particularly limited so long as it is a game for determining winning or losing by using player's cards and dealer's cards, e.g. by comparing hands of player's cards and dealer's cards.

Further, in the first and second embodiments, the case of using playing cards has been described. However, the cards (player's cards and dealer's cards) in the present invention are not limited to playing cards. For example, tarot cards may be used.

Moreover, in the first and second embodiments, the case has been described where the player plays Pai Gow Poker while visually checking the main monitor 2 and the liquid crystal display 10 provided in the station. However, the gaming machine in the present invention may be provided with either the main monitor or the liquid crystal display (display provided in the station). In the case of such a configuration, dealer's cards and player's cards may be displayed to the main monitor or the display of the station.

Although the present invention has been described with reference to embodiments thereof, these embodiments merely illustrate specific examples, not restrict the present invention. The specific structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there has been described processing to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processes described in the present specification are to be executed by various types of devices, in principle. Further, other structures required for conducting each step will be apparent from the aforementioned description.

What is claimed as new and desired to be secured by Letters Patent of the United States is:

1. A gaming machine comprising:
a display capable of displaying a plurality of cards;
an input device; and
a controller,
said controller programmed so as to execute the processing of
(a) accepting a normal BET from said input device,
(b) accepting a side BET different from said normal BET, from said input device,
(c) displaying player's cards and dealer's cards to said display,
(d) executing a normal game for determining winning or losing based on said player's cards and said dealer's cards,
(e) offering a normal payout based on said normal BET when determining that a player has won in said normal game,
(f) determining whether or not a specific card is included in said player's cards when said side BET has been placed, and
(g) offering a special payout when determining in said processing (f) that said specific card is included in said player's cards.

2. The gaming machine according to claim 1,
wherein
said controller is further programmed so as to execute processing of
(h) determining said specific card when said side BET has been placed.

3. The gaming machine according to claim 1,
wherein
said controller is further programmed so as to execute processing of
(i) determining said specific card based on an input from said input device when said side BET has been placed, and
is programmed so as to execute said processing (c) after the processing (i).

4. A gaming machine comprising:
a display capable of displaying a plurality of cards;
an input device; and
a controller,
said controller programmed so as to execute the processing of
(a) accepting a normal BET from said input device,
(b) accepting a side BET different from said normal BET, from said input device,
(c) cumulatively accumulating a predetermined percentage of game media side-bet from said input device,
(d) displaying player's cards and dealer's cards to said display,
(e) executing a normal game for determining winning or losing based on said player's cards and said dealer's cards,
(f) offering a normal payout based on said normal BET when determining that a player has won in said normal game,
(g) determining whether or not a specific card is included in said player's cards when said side BET has been placed, and
(h) offering a special payout from the game media cumulatively accumulated in said processing (c), when determining in said processing (g) that said specific card is included in said player's cards.

5. The gaming machine according to claim 4,
wherein
said controller is further programmed so as to execute processing of
(i) determining said specific card when said side BET has been placed.

6. The gaming machine according to claim 4
wherein
said controller is further programmed so as to execute the processing of
(j) determining said specific card based on an input from said input device when said side BET has been placed, and
is programmed so as to execute the processing of said processing (d) after the processing (J).

7. A playing method of a card game, said method including steps of:
(a) placing a normal BET;
(b) placing a side BET different from said normal BET;
(c) dealing cards to a player as player's cards, while dealing cards to a dealer as dealer's cards;
(d) executing a normal game for determining winning or losing based on said player's cards and said dealer's cards;
(e) offering a normal payout based on said normal BET when determining that a player has won in said normal game;
(f) determining whether or not a specific card is included in said player's cards when said side BET has been placed; and
(g) offering a special payout when determining in said step (f) that the specific card is included in said player's cards.

8. The playing method of a card game according to claim 7, the method further including a step of
(h) determining said specific card when said side BET has been placed.

9. The playing method of a card game according to claim 7, the method further including a step of
(i) determining said specific card based on a selection by said player when said side BET has been placed,
wherein
said step (c) is executed after said step (i).
